(19) United States
(12) Patent Application Publication
(10) Pub. No.: US 2004/0128887 A1
(43) Pub. Date: Jul. 8, 2004

(54) Display device

(76) Inventors: Richard Charles Herbert, Dingley (AU); Stephen Laurence Herbert, Endeavour Hills (AU); Phillip Mario Jude Herbert, Narre Warren (AU)

Correspondence Address: BURNS DOANE SWECKER & MATHIS L L P, POST OFFICE BOX 1404, ALEXANDRIA, VA, 22313-1404, US

(21) Appl. No.: 10/468,522

(22) PCT Filed: Feb. 19, 2002
(86) PCT No.: PCT/AU02/00170

(30) Foreign Application Priority Data
Feb. 19, 2001 (AU) PR 3222

(51) Int. Cl. G09F 15/00

(52) U.S. Cl. 40/606.08

(57) ABSTRACT

A display device (10) is provided for displaying an article (50) of interest in a substantially opaque member (46) such as a table having a utility surface (47). The display device (10) includes a spectacle element (52) incorporated in the opaque member (46) such that the utility surface (47) is substantially uninterrupted at least in the vicinity of the spectacle element (52), and the article (50) to be displayed is capable of being placed behind the spectacle element (52), or at least partly encapsulated in the spectacle element (52), to facilitate viewing of the article (50) from the utility surface (47). A method of displaying an article of interest in a substantially opaque member is also disclosed.

The present invention relates to a display device and more particularly to a device for displaying an article or articles of interest in a substantially opaque surface such as a table top. The article(s) to be displayed may include printed or painted matter, loose or encapsulated three dimensional objects, holograms, LCD screens, photographic prints or slides (including backlit slides), advertisements and decorative items.

The present invention is especially useful for displaying articles such as advertisements in a table top or similar opaque surface and it will therefore be convenient to describe the device in relation to that example application.

However, it should be understood that the invention is not limited to such applications and is intended for broader application and use.

The display device of the present invention may be used in commercial or domestic locations such as, shopping centres, restaurants, food courts, food halls, commercial offices, retail or trade shops, airports, hospitals, public transport stations, lobbies, hotels/motels, public spaces or domestic dwellings.

According to one aspect of the present invention there is provided a table or counter top having a utility surface formed at least partly from a substantially opaque member and adapted for displaying an article of interest in said opaque member, said table or counter top including:

at least one spectacle element fused with said opaque member at an interface such that particles of food, liquids and the like cannot penetrate said interface between said opaque member and said spectacle element, said utility surface being substantially uninterrupted at least in the vicinity of said spectacle element, and means for retaining said article to be displayed behind said at least one spectacle element to facilitate viewing said article from said utility surface.

According to a further aspect of the present invention there is provided a cladding element having an outer surface formed at least partly from a substantially opaque member and adapted for displaying an article of interest in said opaque member, said cladding element including:

at least one spectacle element fused with said opaque member at an interface such that particles of debris, liquids and the like cannot penetrate said interface between said opaque member and said spectacle element, said outer surface being substantially uninterrupted at least in the vicinity of said spectacle element, and means for retaining said article to be displayed behind said at least one spectacle element to facilitate viewing said article from said outer surface.

According to a still further aspect of the present invention there is provided a method of displaying an article of interest in a device such as a table or counter top, or cladding element having a utility or outer surface formed at least partly from a substantially opaque member, said method including the steps of:

providing at least one spectacle element and said article to be displayed;

fusing said spectacle element with said opaque member at an interface such that particles of food, liquids and the like cannot penetrate the interface between said opaque member and said spectacle element, said utility or outer surface being substantially uninterrupted at least in the vicinity of said at least one spectacle element; and

retaining said article of interest behind said at least one spectacle element to facilitate viewing said article from said utility or outer surface.

According to a still further aspect of the present invention there is provided a method of displaying at least one article or object of interest in a substantially opaque member such as a table or counter top, or cladding element, said method including:

providing a spectacle element;

placing the spectacle element in an open mould;

filling the mould with a moulding mix of an opaque material;

curing the opaque material to form said opaque member such that said opaque member is substantially uninterrupted at least in the vicinity of said spectacle element and said article or object is able to be viewed from said opaque member.

According to a still further aspect of the present invention there is provided a method of displaying an article of interest in a substantially opaque member such as a table or counter top, or cladding element, said method including:

providing a sheet or panel of said opaque material;

machining an aperture in a top surface of said sheet or panel; and

fitting and fusing a spectacle element within the machined aperture such that the top surface of said sheet or panel is substantially uninterrupted at least in the vicinity of said spectacle element and placing said article behind said spectacle element such that said article may be viewed from said top surface.

The term opaque as used herein denotes a material or member that is not transparent relative to the spectacle element and may include a translucent material or member.

In one embodiment the opaque member may be a table top and the utility surface may be the top surface of the table. The utility surface may be substantially uninterrupted by inserting the spectacle element into the table top or otherwise uniting the spectacle element with the table top such that an outer surface of the spectacle element is substantially level with the utility surface of the table. Preferably the spectacle element is sealed within the table top such that particles of food, liquids and the like cannot penetrate the interface between the table top and the spectacle element.

In an alternative embodiment the opaque member may be a commercial counter top, such as for a shop or bank, or it may be a vertical panel for use in any of a variety of applications. For example, the opaque member may be a front vertical facia of a shop counter (facing the customer), or it may be the front of a bar or the like.

Other examples of the opaque member may include column cladding, rubbish bin enclosures, checkout counter tops and facia panels on checkout counters, toilet partitioning, bathroom vanity tops, food servery and service counters, facia panels on food service counters, bag shelves, balustrade and stair hand rail infill panels, lift (elevator) car cladding, lift foyer cladding, fold-away tables in aircraft, train or student seats, hospital bed trolley tables, bedside table tops, food trays, vertical or horizontal advertising panels.

The article of interest to be displayed may be a relatively thin object such as a printed sheet or it may be a three dimensional object. In one form the article may include a printed sheet containing a logo for a business, promotional material or customer information. Alternatively, the article of interest may include a medallion, badge, figurine or other object. The article may be at least partly encapsulated within the spectacle element or it may be held within a cavity behind the spectacle element. Typically, a sheet-like object may be placed against an inner surface of the spectacle element.

The opaque member may include a “solid surface material” as is known in the art, including material such as that sold under the name Hytex by HBP Pty. Ltd. or Corian by DuPont. Such materials are typically formed from a moulding mix including a polymer binder and inert fillers. The polymer binder may include vinyl ester, polyester, acrylic, epoxy, polyurethanes, phenolic, melamine a polyester/acrylic mixture or other suitable binding compounds. The fillers may include inert minerals such as alumina, quarts, granite, marble, glass, etc. and/or other suitable materials.

In one embodiment the opaque member may include a substrate formed from a first material and an upper layer, overlaying the substrate, formed from a second material. Preferably the upper layer is formed from a solid surface material as described above. Alternatively, the opaque member may be formed from another suitable material, such as timber, metal, stone, fibreglass, laminate, artificial marble, etc. The substrate may be manufactured from any suitable material such as medium density fibre board (MDF), particle board, compressed cement sheet, etc.

In an alternative embodiment the opaque member may include a single layer such that substantially the full thickness of the opaque member is formed from a uniform material.

The opaque member may be of any suitable thickness according to the application in which it is to be used. Preferably, the opaque member is between 0.75 mm and 100 mm thick. When an upper layer is placed over a substrate the upper layer is preferably between 0.75 mm and 100 mm thick. More preferably, the upper layer is between 0.75 mm and 20 mm thick. When the upper layer is composed of a solid surface material it is preferably between 10 mm and 15 mm thick.

The opaque member may include a built up edge. This edge may be of any desired depth, eg. from 0.75 mm up to several metres. When used as a table top the edge is preferably between 10 mm and 100 mm deep. When an upper layer overlies a substrate, the edge may extend from the upper layer and cover the sides of the substrate.

The spectacle element may be formed from acrylic, polyester, an acrylic/polyester mixture, glass or other suitable transparent or substantially transparent material. In some embodiments the spectacle element may include a concave or convex optical lens to provide a degree of magnification (positive or negative) for the article to be displayed. The spectacle element may be moulded with or otherwise fabricated or fused into the material of the opaque member. In one embodiment the spectacle element may be moulded or fabricated into a solid surface material. In such an embodiment the spectacle element may be fused to the solid surface material with an acrylic, polyester or other suitable binding compound. The spectacle element may alternatively be fabricated into or with other materials.

The spectacle element may be of any desired shape, eg. round, square, rectangular or multi-sided, it may be of any desired size, eg. from 5 mm up to 2000 mm, and of any desired thickness, eg. from 0.75 mm up to 100 mm. In some applications, the spectacle element may be coloured, eg. by adding a colour tint to an acrylic and/or polyester resin.

The spectacle element may be fixed directly to the surrounding surface of the opaque member or it may include a boundary or border element. For example, the opaque member may be provided with a round aperture, of say 100 mm diameter, and the spectacle element may also be round but of smaller diameter, say 75 mm. This may leave an annular space between the opaque member and the spectacle element to accommodate a border of contrasting material. The border may be made of a solid surface material in a contrasting colour, or it may be metal, timber or other suitable material. In an alternative embodiment the aperture may be of one shape and the element may be of a different but smaller shape. In this way an irregular border shape may be created which can be filled with a solid surface moulding mix.

Depending upon the application of the display device, the spectacle element may be positioned anywhere on the opaque member. In the case of a table top, a transparent element may be located at each corner, or centred or spread around the surface in a fixed or random pattern. The number of spectacle elements can also vary from a single element to several elements.

In one embodiment the article to be displayed may be held against the inner surface of the spectacle element by suitable holding means. The holding means may include a plug which may be inserted into an aperture in the opposing surface of the opaque member. In an embodiment having an upper layer overlying a substrate the plug may be accommodated within an aperture in the substrate. In this embodiment the spectacle element may be the same thickness as the upper layer and the plug may be of a similar thickness to the substrate. However, alternative configurations are possible.

In one embodiment the plug may be removable, so that the article to be displayed may be changed as desired. The plug may be secured by mechanical fastening means such as a holding strap, and/or screws, clips, locks or other suitable fasteners. Alternatively, the plug may be rebated or formed with a complementary profile such that it mates with the aperture with or without mechanical fastening. In some embodiments the plug may be formed with a screw thread to engage a complementary thread formed in the aperture. The plug may be secured to the upper layer, to the spectacle element or to the substrate.

In an alternative embodiment the plug may be fixed, so as to permanently enclose the item to be displayed. Any suitable fixing means, such as an adhesive, may be used.

The plug may be of any suitable size or shape. Preferably the plug is at least as large as the spectacle element so as to cover substantially the whole of the inner surface of the spectacle element. The shape of the plug may be the same as the shape of the spectacle element or it may be different. The material and/or colour of the plug may either match the material and colour of the upper layer (or utility surface of the opaque member) or it may contrast therewith.

Alternatively the plug may be dispensed with altogether. A single substrate can be used with mechanical fastening between the top that includes the utility surface and the substrate, in which case the whole top may lift off. Another alternative may be a split substrate, wherein a second substrate covers the first substrate which first substrate also contains the plug. In one form the inner surface of the spectacle element may be left free so that it is possible to see through it. The spectacle element may thus act as a window. An article may be placed or fixed behind the window.

In one embodiment the outer surface of the opaque member may be covered by a transparent layer. The transparent layer may include a clear coating applied as a liquid, such as a gel coat of fibreglass resin or the like. In an embodiment including an upper layer, the transparent layer may cover the upper layer. In this way, the transparent layer may seal the entire outer surface of the opaque member including the spectacle element and interface between the spectacle element and the opaque member/upper layer.

In an alternative embodiment the opaque member may include an upper layer formed from a transparent material such as glass and a substrate formed from an opaque material. The spectacle element may be defined as a portion of the upper layer at which an article can be placed for display. In a further embodiment a surface (preferably the rear surface) of the transparent upper layer may be coated with an opaque material such as paint. A portion of the surface may be left uncoated so as to define the spectacle element. An article can then be placed behind the spectacle element.

The display device may be produced by any one of a number of methods. In one method, a spectacle element may be placed within a closed or open mould. The spectacle element may contain an embedded article or object. The mould may then be filled with a moulding mix of an opaque material as described above. The mix may be left in the mould to solidify and may be cured within the mould or postcured outside the mould. Once cured, the mix may constitute the upper layer of the opaque member, which encapsulates the spectacle element. A substrate may be fixed to a rear surface of the upper layer and a plug, possibly made of the same mix as the upper layer, may be removably secured to an outer surface of the substrate.

In an alternative method, a sheet of suitable material, such as a premoulded solid surface material, may be machined with an aperture to accommodate the spectacle element. The edges of the aperture may be oriented at substantially 90 degrees to the front surface or they may be at an angle so as to accommodate a wedge-shaped element. The spectacle element may be a tight fit within the machined aperture or a gap may be provided around the spectacle element to accommodate a border. The spectacle element may be secured in place with a suitable adhesive, such as an acrylic and/or polyester jointing compound when the opaque member includes a solid surface material, or a compound made from a liquid form of the moulding mix. Once the adhesive has cured the spectacle element may be sanded and polished level with the surface of the surrounding material. The sheet of material may form the upper layer of the opaque member and a substrate may be attached to a rear surface thereof. A plug may then be removably secured to the substrate.

In a further method, a sheet of solid surface material, or other suitable material, may be machined or moulded with an open cavity, such that the cavity is accessible from the outer surface of the sheet but not from its inner surface. An article or printed matter may be placed within the cavity, so as to face the outer surface, and the cavity may then be filled with a transparent moulding compound, such as clear liquid polyester or acrylic resin. The resin may be allowed to set and may then be sanded and polished level with the surface of the surrounding material.

To assist further understanding of the present invention, reference is now made to the accompanying drawings which illustrate preferred embodiments of the display device. It is to be appreciated that the embodiments are given by way of illustration only and the invention is not to be limited by these illustrations.

In the drawings:

FIG. 1 shows a top view of a table top incorporating one embodiment of a display device according to the present invention;

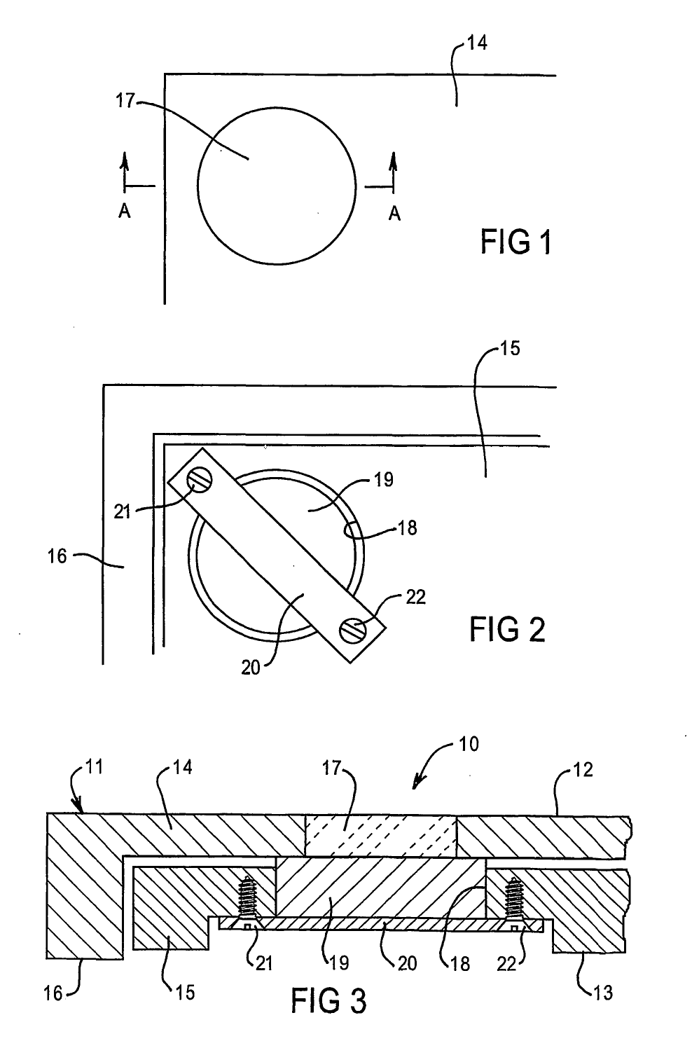

FIG. 2 shows a view of the underside of the table top of FIG. 2;

FIG. 3 shows a cross-sectional view A-A of a corner of the table top shown in FIG. 1 incorporating one embodiment of a display device according to the present invention;

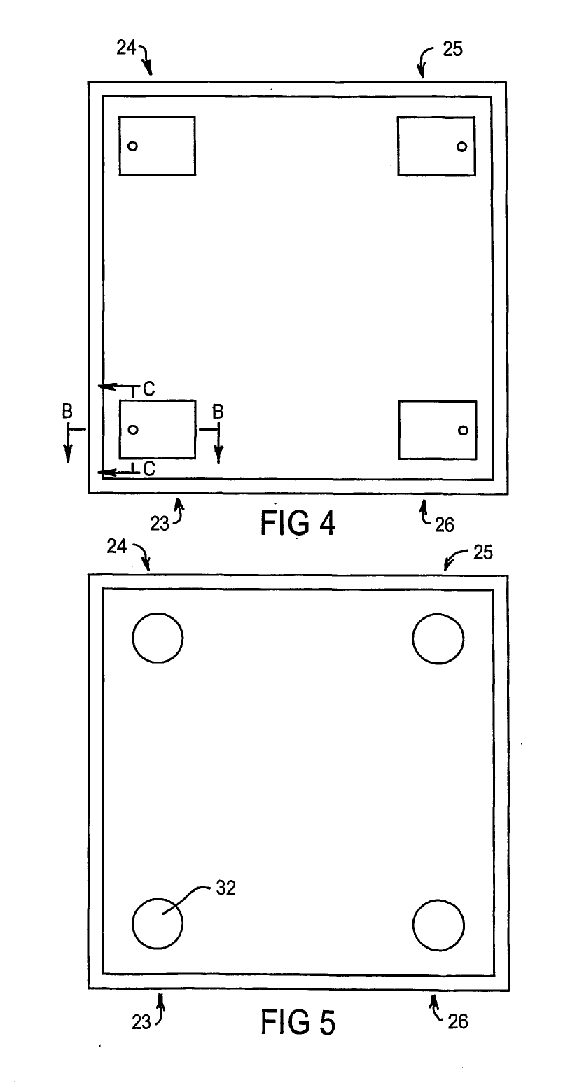

FIG. 4 shows an underside view of a tabletop with substrate incorporating a further embodiment of a display device according to the present invention;

FIG. 5 shows an underside view similar to FIG. 4 but with the substrate removed;

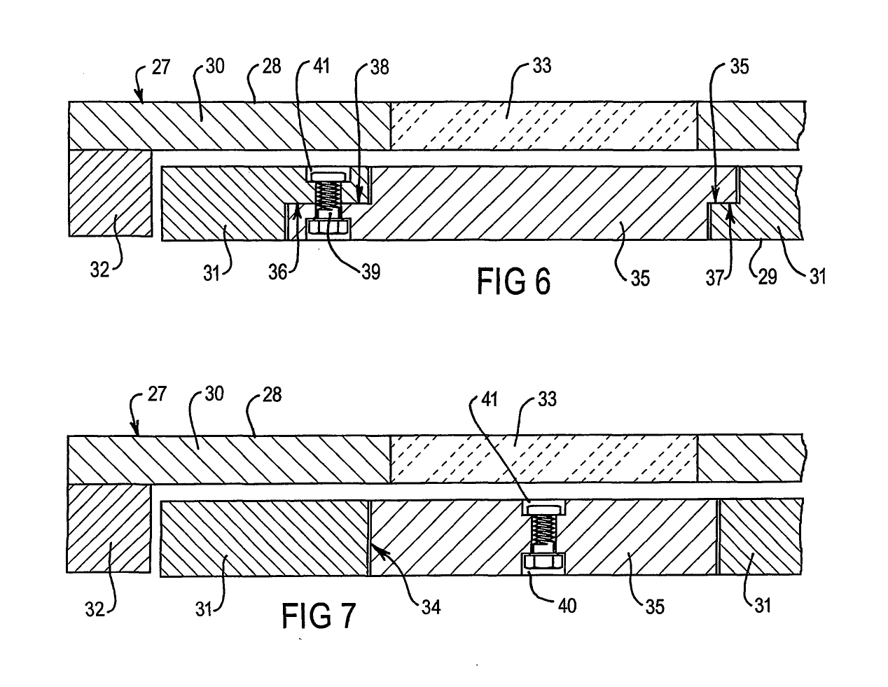

FIG. 6 shows a cross-sectional view B-B of one corner of the table top shown in FIG. 4;

FIG. 7 shows a cross section view C-C of the one corner of tabletop show in FIG. 4;

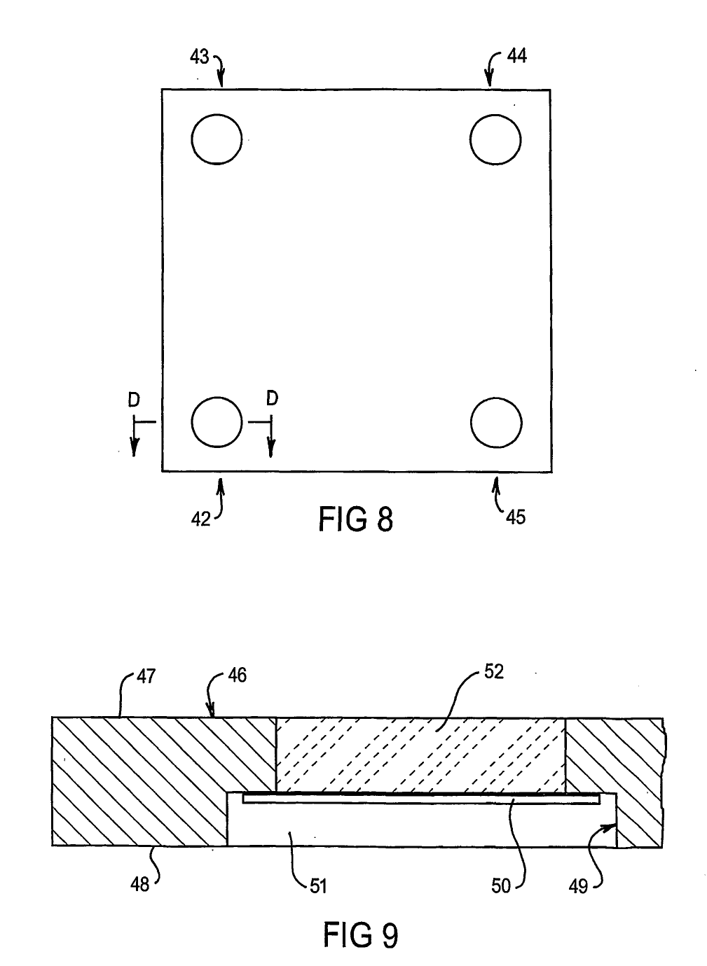

FIG. 8 shows an underside view of a tabletop incorporating a further embodiment of a display device according to the present invention;

FIG. 9 shows a cross sectional view D-D of one corner of the table top shown in FIG. 8;

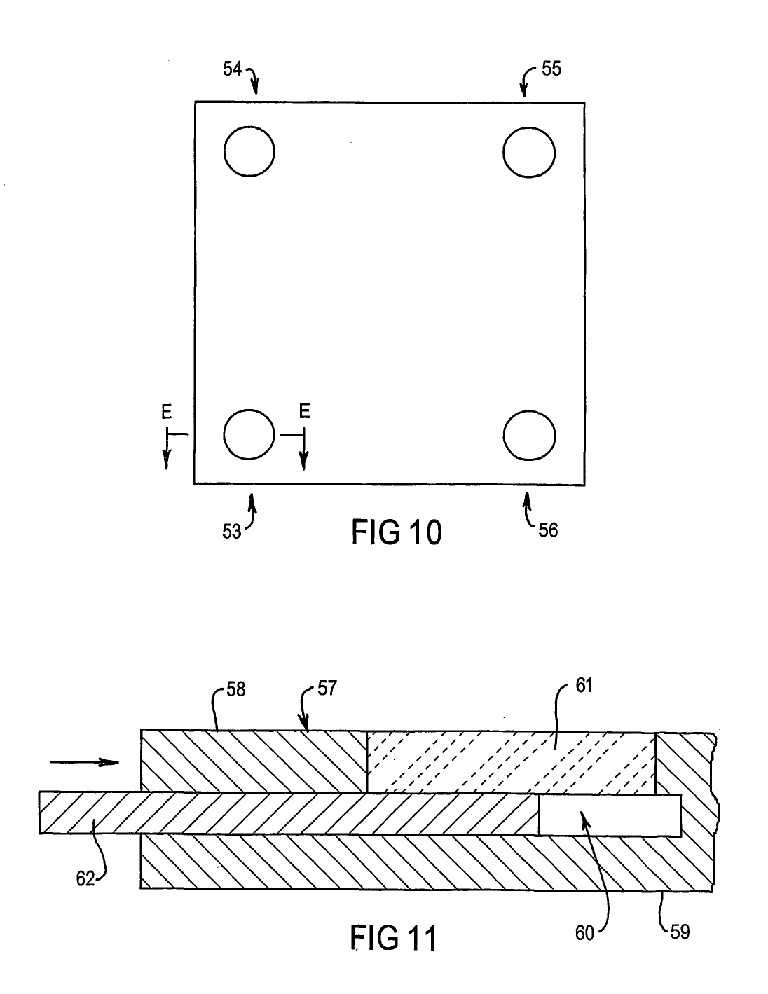

FIG. 10 shows an underside view of a table top incorporating a further embodiment of a display device according to the present invention;

FIG. 11 shows a cross sectional view E-E of one corner of the table top shown in FIG. 10;

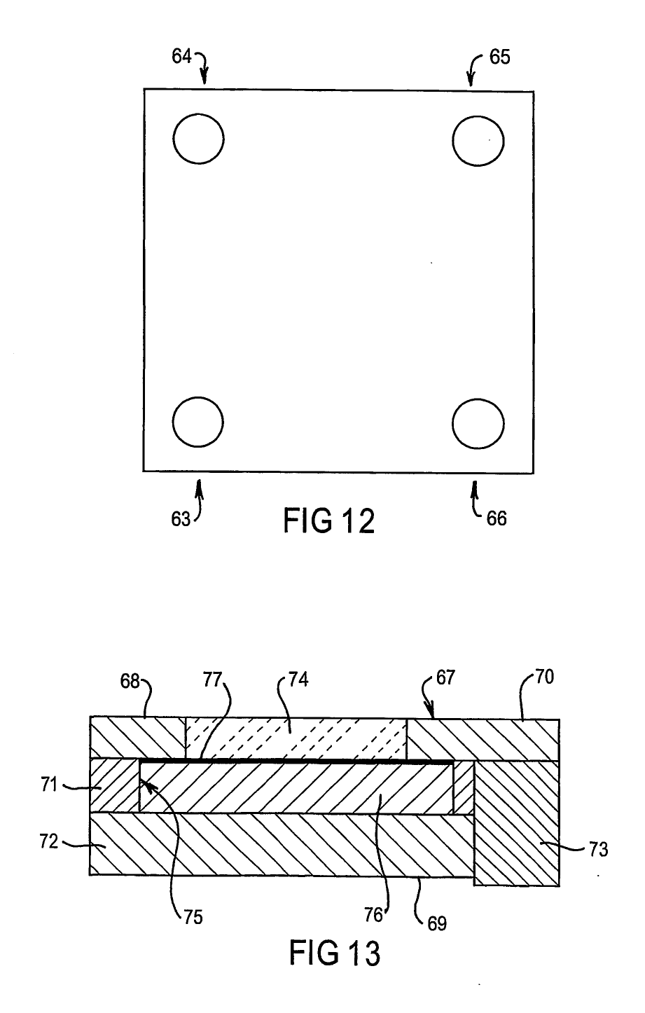

FIG. 12 shows an underside view of a table top incorporating a further embodiment of a display device according to the present invention;

FIG. 13 shows a cross sectional view F-F of one corner of the table top shown in FIG. 12; and

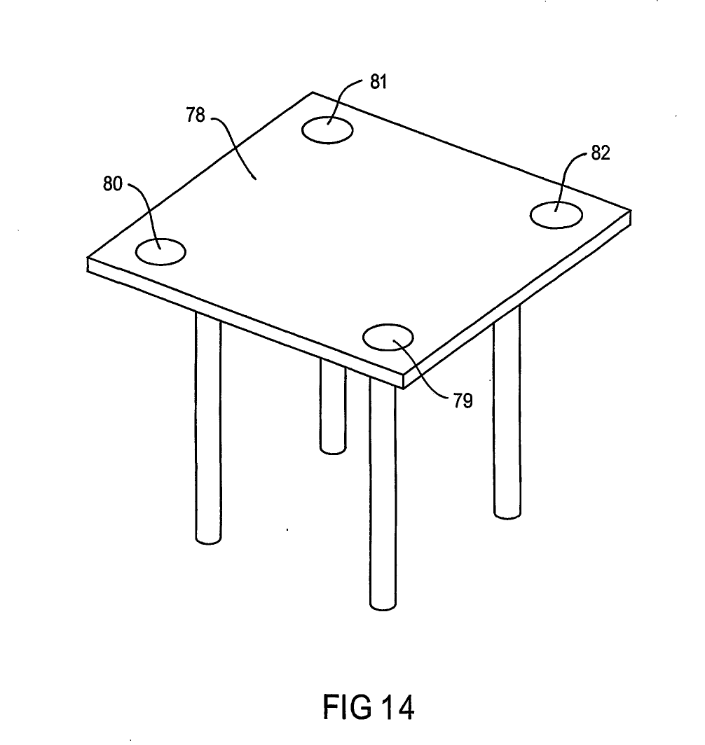

FIG. 14 shows a table incorporating four display devices according to the present invention.

Referring to the drawings, FIGS. 1 to 3 show a corner of a table top incorporating a display device 10 according to the present invention. The table top includes an opaque member 11 having a utility surface 12 and an opposing surface 13. In the embodiment shown, the opaque member 11 comprises an upper layer 14 made of a solid surface material, and a substrate 15 made of particle board or similar material. The upper layer 14 is secured to the substrate 15 by means of a flexible adhesive so as to allow for differential expansion therebetween. A built up edge 16 is formed on the upper layer 14 so as to extend down over the side of substrate 15.

The upper layer 14 of opaque member 11 includes a round spectacle element 17 made of a clear or transparent polyester or acrylic resin material. The spectacle element 17 is fused into the surrounding solid material of the upper surface layer 14, either by being moulded into the latter material or by being bonded thereto by means of a polyester or acrylic jointing compound.

Aligned with the spectacle element 17, substrate 15 has a round aperture 18 concentrically aligned with spectacle element 17 and containing a removable plug 19. The plug 19 is held in place by a holding strap 20 which is fixed to the substrate 15 by means of screws 21, 22.

In use, the plug 19 is removed by unscrewing the holding strap 20 from the underside of the table. An article to be displayed (not shown) may be inserted into the aperture 18 and held in place by reinserting the plug 19. The holding strap 20 is then reinstalled.

The display device 10 provides a convenient means for displaying printed material within a table top. The spectacle element 17 is fused into the upper layer 14 of the table top, thereby eliminating crevices which can collect dirt and harbour bacteria. The table top incorporating the display device 10 may therefore be suitable for use in food outlet or similar applications where hygiene is important.

FIGS. 4 and 5 show a table top incorporating four display devices 23-26 according to the present invention. One display device 23 is described below since the other devices 24-26 may be substantially identical.

Referring to FIGS. 6-7, the table top includes an opaque member 27 having a utility surface 28 and an opposing surface 29. The opaque member 27 comprises an upper layer 30 and a substrate 31. The upper layer 30 is secured to substrate 31 in any suitable manner and by any suitable means. A built up edge 32 is formed on the upper layer 30 so as to extend down over the side of substrate 31. Upper layer 30 includes a round spectacle element 33 formed from a clear or transparent polyester or acrylic resin or the like. The spectacle element 33 is fused Into the surrounding material of upper layer 30 in any convenient manner and by any suitable means. Substrate 31 includes a rectangular aperture 34 substantially aligned with spectacle element 33 and containing a removable plug 35. Aperture 34 is formed with steps 35, 36 and plug 35 is formed with complementary steps 37, 38 to mate with steps 35, 36 of aperture 34 when plug 35 is inserted into aperture 34. A recessed bolt 39 is inserted through steps 36, 38. Bolt 39 is inserted in a recess 40 in plug 35 which receives the head of bolt 39 and a washer and includes T-nut 41 engaging substrate 31.

FIG. 8 shows a table top incorporating four display devices 42 to 45 according to the present invention. One display device 42 is described below since the other display devices 43 to 45 may be substantially identical.

Referring to FIG. 9, the table top includes an opaque member 46 having a utility surface 47 and opposing surface 48. The opaque member 46 is formed from a solid uniform material such as a solid surface material as described herein. Opaque member 46 includes a recess 49 for receiving an article of interest 50 and a plug or plate 51. Opaque member 46 includes a round spectacle element 52 formed from a clear or transparent polyester or acrylic resin or the like. The spectacle element 52 is positioned substantially above recess 49 and is fused into the surrounding material of opaque member 46 in any suitable manner and by any suitable means.

FIG. 10 shows a table top incorporating four display devices 53 to 56 according to the present invention. One display device 53 is described below since the other display devices 54-56 may be substantially identical.

Referring to FIG. 11, the table top includes an opaque member 57 having a utility surface 58 and opposing surface 59. The opaque member 57 is formed from a solid uniform material such as the solid surface material described herein. Opaque member 57 includes a horizontally extending slot or cavity 60 formed in its body. The slot or cavity 60 extends from an edge or edges of the table top towards spectacle element 61 which is formed in a portion of opaque member 57 that lies above slot or cavity 60. Spectacle element 61 is fused with the surrounding material of opaque member 57 in any convenient manner and by any suitable means. An insert 62 is adapted to slide into slot or cavity 60. The insert 62 may include an article to be displayed (not shown) at least partly embedded therein. The article to be displayed may be fixed to a surface of insert 62 that faces spectacle element 61 or it may be fully encapsulated within insert 62.

FIG. 12 shows a table top incorporating four display devices 63 to 66 according to the present invention. One display device 63 is described below since the other display devices 64 to 66 may be substantially identical.

Referring to FIG. 13, the table top includes an opaque member 67 having a utility surface 68 and an opposing surface 69. The opaque member 67 comprises an upper layer 70 and a split substrate comprising upper substrate 71 and lower substrate 72. The upper layer 70 is secured to upper substrate 71 in any suitable manner and by any suitable means. A built up edge 73 is formed on the upper layer 70 so as to extend down over the side of substrates 71, 72.

Upper layer 70 includes a round spectacle element 74 formed from a clear or transparent polyester or acrylic resin or the like. The spectacle element 74 is fused into surrounding material of upper layer 70 in any suitable manner and by any suitable means. Upper substrate 71 includes an aperture 75 substantially aligned with the spectacle element 74 and containing a removable plug 76. An article 77 to be displayed is fixed to the surface of plug 76 facing spectacle element 74. Plug 76 is retained in aperture 75 by lower substrate 72 which is fixed to upper substrate 71 in any suitable manner and by any suitable means.

FIG. 14 shows a table including a table top 78 into which display elements 79 to 82 each made according to the present invention, have been incorporated.

Although a preferred embodiment of the invention is described herein in detail, it will be understood by those skilled in the art that variations may be made thereto without departing from the spirit or scope of the invention.

1. A table or counter top having a utility surface formed at least partly from a substantially opaque member and adapted for displaying an article of interest in said opaque member, said table or counter top including:
at least one spectacle element fused with said opaque member at an interface such that particles of food, liquids and the like cannot penetrate said interface between said opaque member and said spectacle element, said utility surface being substantially uninterrupted at least in the vicinity of said spectacle element, and means for retaining said article to be displayed behind said at least one spectacle element to facilitate viewing said article from said utility surface.

2. A cladding element having an outer surface formed at least partly from a substantially opaque member and adapted for displaying an article of interest in said opaque member, said cladding element including:
at least one spectacle element fused with said opaque member at an interface such that particles of debris, liquids and the like cannot penetrate said interface between said opaque member and said spectacle element, said outer surface being substantially uninterrupted at least in the vicinity of said spectacle element, and means for retaining said article to be displayed behind said at least one spectacle element to facilitate viewing said article from said outer surface.

3. A device according to claim 1 or 2 wherein said article of interest includes an LCD display screen.

4. A device according to claim 1 or 2 wherein said article of interest includes backlit prints or slides.

5. A device according to any one of the preceding claims wherein said article of interest includes an advertisement.

6. A device according to any one of the preceding claims wherein said retaining means includes means for removably retaining said article of interest.

7. A device according to any one of the preceding claims including a substrate behind said utility or outer surface wherein said retaining means includes an aperture in said substrate substantially aligned with said at least one spectacle element and a plug adapted to be removably received in said aperture.

8. A device according to any one of claims 1 to 6 including upper and lower substrates behind said utility or outer surface wherein said retaining means includes an aperture in said upper substrate substantially aligned with said at least one spectacle element and a plug adapted to be removably received in said aperture.

9. A device according to any one of claims 1 to 6 wherein said retaining means includes a slot or cavity formed in said opaque member and extending from an edge of said device, said slot or cavity being substantially aligned with said at least one spectacle element, and an insert adapted to be removably received in said slot or cavity.

10. A device according to any one of claims 1 to 6 including a substrate behind said utility or outer surface wherein said utility or outer surface is arranged to lift off said substrate.

11. A device according to any one of the preceding claims wherein the or each spectacle element is moulded with said opaque member.

12. A device according to any one of claims 1 to 10 wherein the or each spectacle element is bonded with said opaque member by means of an acrylic, polyester, or other suitable jointing compound.

13. A device according to any one of the preceding claims wherein said opaque member includes a solid surface material as defined herein.

14. A device according to any one of the preceding claims wherein the or each spectacle element is substantially rectangular or square.

15. A device according to any one of claims 1 to 13 wherein the or each spectacle element is substantially round or multisided.

16. A method of displaying an article of interest in a device such as a table or counter top, or cladding element having a utility or outer surface formed at least partly from a substantially opaque member, said method including the steps of:
providing at least one spectacle element and said article to be displayed;
fusing said spectacle element with said opaque member at an interface such that particles of food, liquids and the like cannot penetrate the interface between said opaque member and said spectacle element, said utility or outer surface being substantially uninterrupted at least in the vicinity of said at least one spectacle element; and
retaining said article of interest behind said at least one spectacle element to facilitate viewing said article from said utility or outer surface.

17. A method according to claim 16 wherein said article of interest includes an LCD display screen.

18. A method according to claim 16 wherein said article of interest includes backlit prints or slides.

19. A method according to claim 16, 17 or 18 wherein said article of interest includes an advertisement.

20. A method according to any one of claims 16 to 19 wherein said step of retaining includes removably retaining said article of interest.

21. A method according to any one of claims 16 to 19 wherein said device includes a substrate behind said utility or outer surface and said step of retaining includes providing an aperture in said substrate substantially aligned with said at least one spectacle element, and removably locating a plug in said aperture.

22. A method according to any one of claims 16 to 19 wherein said device includes upper and lower substrates behind said utility or outer surface and said step of retaining includes providing an aperture in said upper substrate substantially aligned with said at least one spectacle element, and removably locating a plug in said aperture.

23. A method according to any one of claims 16 to 19 wherein said step of retaining includes providing a slot or cavity in said opaque member extending from an edge of said top or panel, said slot or cavity being substantially aligned with said at least one spectacle element, and removably locating an insert in said slot or cavity.

24. A method according to any one of claims 16 to 19 including a substrate fastened behind said opaque member such that said opaque member can lift off said substrate.

25. A method according to any one of claims 16 to 24 wherein said step of fusing includes moulding the or each spectacle element with said opaque member.

26. A method according to any one of claims 16 to 24 wherein said step of fusing includes bonding the or each spectacle element with said opaque member by means of an acrylic, polyester or other suitable jointing compound.

27. A method according to any one of claims 16 to 26 wherein said opaque member includes a solid surface material as defined herein.

28. A method according to any one of claims 16 to 27 wherein the or each spectacle element is substantially rectangular or square.

29. A method according to any one of claims 16 to 27 wherein the or each spectacle element is substantially round or multisided.

30. A method according to any one of claims 16 to 29 wherein a plurality of spectacle elements is spread around the utility or outer surface in a fixed pattern.

31. A method according to any one of claims 16 to 29 wherein a plurality of spectacle elements is spread around the utility or outer surface in a random pattern.

32. A method of displaying at least one article or object of interest in a substantially opaque member such as a table or counter top, or cladding element, said method including:
providing a spectacle element;
placing the spectacle element in an open mould;
filling the mould with a moulding mix of an opaque material;
curing the opaque material to form said opaque member such that said opaque member is substantially uninterrupted at least in the vicinity of said spectacle element and said article or object is able to be viewed from said opaque member.

33. A method according to claim 32 wherein said step of curing includes fusing said spectacle element with said opaque material at an interface such that particles of food, liquids and the like cannot penetrate said interface.

34. A method according to claim 33 including placing said article or object behind said spectacle element such that said spectacle element protects said article or object from contact with said particles of food, liquids and the like placed on or against said opaque member.

35. A method according to claim 32, 33 or 34 wherein said article or object is held within a cavity behind said spectacle element.

36. A method according to claim 32, 33 or 34 wherein said article or object is placed against an inner surface of said spectacle element.

37. A method according to any one of claims 32 to 36 wherein said spectacle element is surrounded by a border of contrasting material.

38. A method according to claim 37 wherein said border material is of a different shape to said spectacle element.

39. A method according to any one of claims 26 to 38 including mechanically fastening a substrate to a rear surface of said opaque member such that said opaque member can lift off said substrate.

40. A method of displaying an article of interest in a substantially opaque member such as a table or counter top, or cladding element, said method including:
providing a sheet or panel of said opaque material;
machining an aperture in a top surface of said sheet or panel; and
fitting and fusing a spectacle element within the machined aperture such that the top surface of said sheet or panel is substantially uninterrupted at least in the vicinity of said spectacle element and placing said article behind said spectacle element such that said article may be viewed from said top surface.

41. A device for displaying an article of interest substantially as herein described with reference to one or more of the accompanying drawings.

42. A method of displaying an article substantially as herein described with reference to one or more of the accompanying drawings.
